(19) United States
(12) Patent Application Publication
(10) Pub. No.: US 2026/0117978 A1
(43) Pub. Date: Apr. 30, 2026

(54) BIMETALLIC HYDROGEN FUEL NOZZLE WITH MULTIPLE FLOW CIRCUITS

(71) Applicant: PRATT & WHITNEY CANADA CORP., Longueuil (CA)

(72) Inventors: Luca Agopian, Montreal (CA); Jean-Rene Poulin, Saint-Hubert (CA); Mathieu Fagnan, Lasalle (CA)

(21) Appl. No.: 19/370,412

(22) Filed: Oct. 27, 2025

Related U.S. Application Data
(60) Provisional application No. 63/712,950, filed on Oct. 28, 2024.

(51) Int. Cl. F23R 3/28; B22F 10/60; B33Y 10/00; B33Y 40/20; B33Y 80/00

(52) U.S. Cl. CPC F23R 3/28; B22F 10/60; B33Y 10/00; B33Y 40/20; B33Y 80/00

(57) ABSTRACT

A hydrogen fuel nozzle for a gas turbine engine has a plurality of flow circuits, each of which is configured to flow one of a fuel or an oxidizer to a gas turbine engine combustor positioned downstream of the hydrogen fuel nozzle when the gas turbine engine is assembled. At least one of the plurality of flow circuits is a hydrogen flow circuit configured to flow hydrogen to the gas turbine engine combustor. The hydrogen fuel nozzle is formed using an additive manufacturing (AM) technique. A non-hydrogen-exposed zone of the hydrogen fuel nozzle is made with a first material which is a conventional high temperature capable alloy. A hydrogen-exposed zone of the hydrogen fuel nozzle is made with a second material, which is a hydrogen-compatible alloy.

### CROSS-REFERENCE TO RELATED APPLICATION(S)

This application claims the benefit of U.S. Provisional Application No. 63/712,950, filed Oct. 28, 2024, and entitled “Bimetallic Hydrogen Fuel Nozzle with Multiple Flow Circuits,” the disclosure of which is hereby incorporated by reference in its entirety.

### BACKGROUND

The present disclosure relates generally to a hydrogen fuel nozzle for a gas turbine engine and, more particularly, to a hydrogen fuel nozzle made for a gas turbine engine with additive manufacturing (AM) techniques.

The use of hydrogen as an alternative fuel for aircraft engines has gained attention in recent years due to an increased demand for sustainable fuels. Incorporating hydrogen as an aircraft engine fuel in a feasible manner brings certain challenges. One of these challenges is leakage that may occur in traditional jointed components due to the small size of hydrogen molecules. Hydrogen molecules that may leak into connected joints can cause hydrogen embrittlement and premature combustion. Further, hydrogen embrittlement can occur in metal parts is in contact with hydrogen molecules, such as fuel nozzles or fuel injectors, regardless of leakage.

### SUMMARY

One aspect of this disclosure is directed to a hydrogen fuel nozzle for a gas turbine engine having a plurality of flow circuits, each of which is configured to flow one of a fuel or an oxidizer to a gas turbine engine combustor positioned downstream of the hydrogen fuel nozzle when the gas turbine engine is assembled. At least one of the plurality of flow circuits is a hydrogen flow circuit configured to flow hydrogen to the gas turbine engine combustor. The hydrogen fuel nozzle is formed using an additive manufacturing (AM) technique. A non-hydrogen-exposed zone of the hydrogen fuel nozzle is made with a first material which is a conventional high temperature capable alloy. A hydrogen-exposed zone of the hydrogen fuel nozzle is made with a second material, which is a hydrogen-compatible alloy.

Another aspect of the disclosure is directed to a method of making a hydrogen fuel nozzle for a gas turbine engine. A hydrogen fuel nozzle is integrally formed using an AM technique. A non-hydrogen-exposed zone of the hydrogen fuel nozzle is made with a first material which is a conventional high temperature capable alloy. A hydrogen-exposed zone of the hydrogen fuel nozzle is made with a second material, which is a hydrogen-compatible alloy. The hydrogen fuel nozzle has a plurality of flow circuits, each of which is configured to flow one of a fuel or an oxidizer to a gas turbine engine combustor positioned downstream of the hydrogen fuel nozzle when the gas turbine engine is assembled. At least one of the plurality of flow circuits is a hydrogen flow circuit configured to flow hydrogen to the gas turbine engine combustor. The hydrogen fuel nozzle is post-processed to remove support structures formed in the hydrogen fuel nozzle during the AM process. A surface finishing operation is performed on the hydrogen flow circuit to provide an inside diameter of the hydrogen flow circuit with a surface finish selected to limit hydrogen embrittlement.

### BRIEF DESCRIPTION OF THE DRAWINGS

FIG. 1A is a schematic view of a hydrogen fuel nozzle for a gas turbine engine positioned on a powder bed fusion (PBF) additive manufacturing (AM) build plate.

FIG. 1B is another schematic view of a hydrogen fuel nozzle for a gas turbine engine positioned on a powder bed fusion (PBF) additive manufacturing (AM) build plate.

FIG. 2 is a flow chart of a method for building a hydrogen fuel nozzle for a gas turbine engine.

FIG. 3A is a schematic view of a hydrogen flow passage with a rough (“as built”) internal diameter surface.

FIG. 3B is a schematic view of a hydrogen flow passage after a surface finishing operation to smooth the internal diameter surface.

FIG. 4 is a schematic view of a bimetallic powder bed fusion (PBF) additive manufacturing (AM) system.

FIG. 5 is a schematic view of another bimetallic PBF AM system.

FIG. 6 is a schematic view of an arc wire bimetallic AM system.

### DETAILED DESCRIPTION

As discussed, because hydrogen is under consideration as a fuel for aircraft engines, certain challenges must be addressed. These challenges include hydrogen embrittlement and hydrogen leakage across connected joints. One approach to addressing hydrogen leakage across connected joints is to use jointless manufacturing techniques, including additive manufacturing (AM) techniques. AM techniques can reduce or eliminate the need for connected joints with good engineering design approaches and effective use of AM techniques. Further, AM techniques can be used to form complicated geometrical features that may be desirable for a hydrogen fuel nozzle, such as various swirling or fuel premixing features.

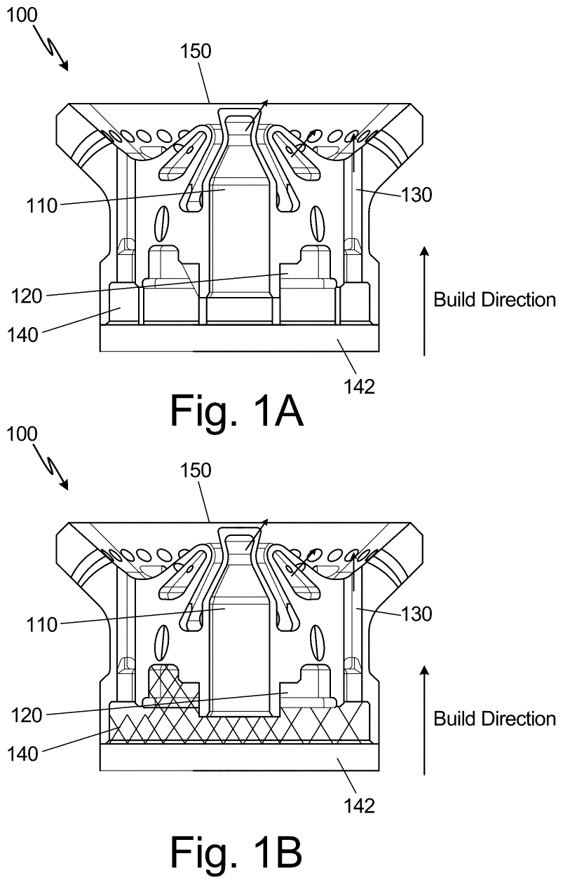

FIGS. 1A and 1B are schematics of a hydrogen fuel nozzle 100 that includes a plurality of flow circuits, each of which is configured to flow one of a fuel or an oxidizer (e.g., air) to a gas turbine engine combustor (not shown) positioned downstream of the hydrogen fuel nozzle 100 when the gas turbine engine is assembled. As discussed further below, at least one of the plurality of flow circuits is configured to flow hydrogen to the gas turbine engine combustor. For example, the hydrogen fuel nozzle 100 of FIGS. 1A and 1B include a primary flow circuit 110, a secondary flow circuit 120, and a tertiary flow circuit 130. A person of ordinary skill will recognize the hydrogen fuel nozzle 100 may include more then or fewer than three flow circuits 110, 120, 130. FIGS. 1A and 1B also show a plurality of support structures 140 formed adjacent to a AM manufacturing system build plate 142. FIG. 1A shows the plurality of support structures 140 as formed during the AM build process. FIG. 1B shows with overlaid “X”'s, which of the plurality of support structures 140 are removed in a post AM build processing operation. In some examples, all of the flow circuits can be directed to hydrogen. In other examples, at least one of the flow circuits can be directed to hydrogen with the remaining flow circuits being directed to air. In yet other examples, one of the flow circuits can be directed to a liquid hydrocarbon fuel (e.g., Jet A, a sustainable aviation fuel equivalent to Jet A, or another liquid hydrocarbon fuel), another of the flow circuits can be directed to air, and another of the flow circuits can be directed to hydrogen. In the examples of FIGS. 1A and 1B, the primary flow circuit 110 can be directed to a liquid hydrocarbon fuel, the secondary flow circuit 120 can be directed to air, and the tertiary flow circuit 130 can be directed to hydrogen. The assignment of liquid fuel, air, and hydrogen to a particular flow circuit can be selected based on whatever arrangement is deemed appropriate for a particular application. For an application such as the hydrogen fuel nozzle 100, hydrogen can be provided as a pressurized gas so that it mixes well with liquid fuel and air streams.

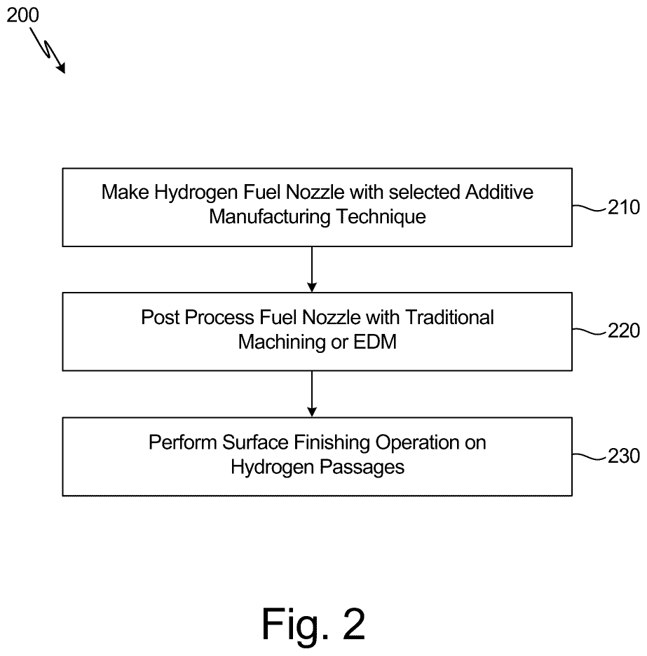

FIG. 2 is a flow chart of an overall process 200 for building a hydrogen fuel nozzle 100 of this disclosure. At step 210, a selected AM technique is used to make the hydrogen fuel nozzle 100. The AM technique can be any AM technique deemed suitable for a particular hydrogen fuel nozzle 100. For example, the selected AM technique can be Powder Bed Fusion (PBF), e.g., Laser PBF (PBF-LB) or Electron Beam PBF (PBF-EB), Directed Energy Deposition (DED), e.g., Laser Powder DED (DED-LB) or Electron Beam Wire DED (DED-EBW), Arc Wire DED (DED-AW), Cold Spray, Binder Jetting, Metal Extrusion (MEX), or any other AM technique deemed for a particular hydrogen fuel nozzle 100. The considerations that can be used to select a particular AM technique for making the hydrogen fuel nozzle 100 can include, but are not limited to, the materials from which the fuel nozzle 100 will be made, the specific details of the hydrogen fuel nozzle 100 that will be made with AM techniques, and the surface finish produced by the selected AM technique.

Because of the challenges associated with hydrogen embrittlement, portions of the hydrogen fuel nozzle 100 that come into contact with hydrogen, referred to as a “hydrogen-exposed zone,” should be made with a hydrogen-compatible alloy designed to limit the impact of hydrogen embrittlement. For example, if tertiary flow circuit 130 is directed to hydrogen as described above, portions of the hydrogen fuel nozzle 100 in the vicinity of tertiary flow circuit 130 would be considered to be part of the “hydrogen-exposed zone” of the hydrogen fuel nozzle 100. All other portions of the hydrogen fuel nozzle 100 can be considered as a “non-hydrogen-exposed zone” and can be made with conventional high temperature capable alloys. In some examples, the hydrogen-exposed zone can include material within 50 mm of surfaces exposed to hydrogen. In other examples, the hydrogen-exposed zone can be larger or smaller then 50 mm. The depth of the hydrogen-exposed zone should be determined based on the operating conditions of a particular application and the portion of the hydrogen fuel nozzle 100 considered to be within the hydrogen-exposed zone for manufacturing purposes should be made from a hydrogen-compatible alloy. All other portions of the hydrogen fuel nozzle 100, i.e., the portions in the non-hydrogen exposed zone, can be made from conventional high temperature capable alloys. As a result, the hydrogen fuel nozzle 100 of this disclosure includes a bimetallic hydrogen fuel nozzle, i.e., a hydrogen fuel nozzle made from two metals.

Examples of hydrogen-compatible alloys include, without limitation, Inconel® 600 nickel-chromium-iron superalloy, Inconel® 625 nickel-chromium superalloy, NASA HR-1 iron-nickel superalloy, and similar alloys. Examples of conventional high temperature capable alloys include without limitation MAR-M200 (59.5Ni-9Cr-10Co-12.5W-1.8Nb-2Ti-5Al-0.05Zr-0.15C-0.015B), Waspaloy (58Ni-19Cr-13Co-4Mo-3Ti-1.4Al), Rene 95 (61Ni-14Cr-8Co-3.5Mo-3.5W-3.5Nb-2.5Ti-3.5Al-0.16C-0.01B-0.05Zr), Inconel® 100 superalloy (60Ni-10Cr-15Co-3Mo-4.7Ti-5.5Al-0.15C-0.015B-0.06Zr-1.0V), and similar nickel-based superalloys and GRCop-84 (Cu-8Cr-4Nb) (at %), GRCop-42 (Cu-4Cr-2Nb) (at %) and similar copper-based alloys.

For use with a selected AM technique, the hydrogen-compatible alloys and conventional high temperature capable alloys should be provided in appropriate form, e.g., powder or wire form, with a powder or wire meeting the specifications associated with the selected AM technique. As described further below, a bimetallic AM technique can be used to build the bimetallic hydrogen fuel nozzle 100 of this disclosure.

At step 220, the hydrogen fuel nozzle 100 made with the selected AM technique of step 210 can be subjected to one or more selected post-processing steps depending on the selected AM technique. For example, the one or more selected post-processing steps may be used to remove support structures 140 at the bottom of the build plate 142 used to create features that may not be possible with selected AM technique, or used for any other purpose deemed appropriate for a particular hydrogen nozzle 100. Examples of suitable post-processing steps include mechanical machining (e.g., grinding, cutting, drilling, milling, etc.), chemical processing (e.g., chemical material removal processes, coating processes, etc.), electro-discharge machining (EDM), or other post-processing methods. In one example, an EDM post-processing step can be used to create features that may not be possible with current AM techniques.

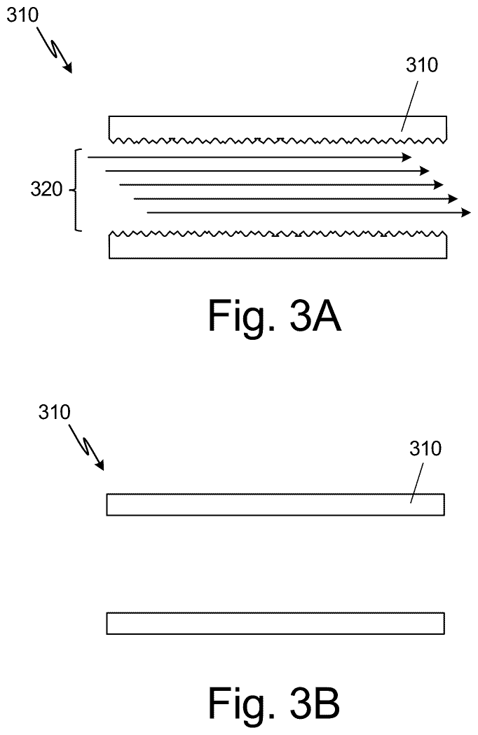

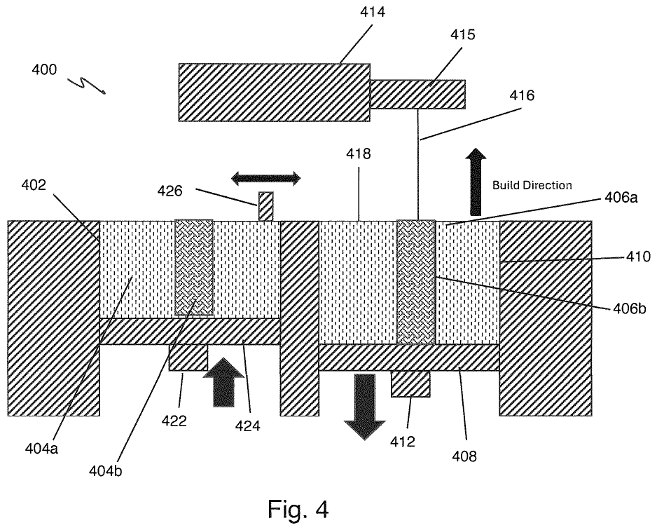

At step 230, selected passageways in one of the plurality of flow circuits 110, 120, 130 in hydrogen fuel nozzle 100, particularly passageways that are configured for hydrogen flow, are polished to achieve a desired surface finish. Exemplary polishing processes include chemical milling, chemical/mechanical etching, a selected electrochemical process or any other suitable polishing process may be used to produce a desired surface finish. FIGS. 3A and 3B show such a polish process schematically, with FIG. 3A showing a selected hydrogen flow passage 310 having an inside diameter (ID) surface 320 with a rough (“as built”) surface finish. FIG. 3A also shows selected chemical finishing reagent 330 flowed through the ID surface 320. The chemical reagent 330 is selected to perform a chemical milling operation on ID surface 320 to produce a desired smoother surface finish. FIG. 3B shows that the same selected hydrogen flow passage 310 after the chemical milling step has an ID surface 320 with a smooth surface finish selected to limit hydrogen embrittlement. Providing an ID surface 320 a smooth surface finish reduces hydrogen embrittlement by reducing the surface area available for direct hydrogen contact and removing fissures and pores in which hydrogen can accumulate. Achieving the desired smoother surface finish for ID surface 320 may require plugging some flow circuit 110, 120, 130 holes as discussed further below to limit the chemical milling operation to selected passageways (see FIGS. 4A-4C).

While the desired specific improvement in ID surface 320 surface finish can vary from application to application, the overall goal of step 230 is to reduce the roughness of the ID surface 320 to form a much smoother surface finish then available by AM techniques only. For example, depending on the specific application, it may be desirable to achieve an average surface roughness of less than 20 μm for a particular ID surface 320. In other applications, particularly applications that will involve extensive use of hydrogen fuel, it may be desirable to achieve an average surface roughness of less than 5 μm or even less than 3 μm for ID surface 320 used in a hydrogen fuel flow circuit.

Suitable chemical milling reagents can include hydrochloric acid (HCl), nitric acid (HNO₃), other chemical milling reagents, and mixtures of chemical milling reagents including dilutions of chemical milling reagents with an alcohol such as ethanol or another alcohol. Other reagents are also possible depending on the material used to build the hydrogen fuel nozzle 100. In some examples, polish techniques other than chemical milling can be used to improve the surface finish of ID surface 320. For example, mechanical milling or other mechanical, electrical, or chemical methods can be used to improve the surface finish of ID surface 320.

FIGS. 4 to 6 are schematic views of bimetallic AM systems that can be used to build the bimetallic hydrogen fuel nozzle 100 of this disclosure.

FIG. 4 shows a PBF AM system 400 that can be used to implement PBF-L and PBF-EB AM techniques to build the bimetallic hydrogen fuel nozzle 100 of this disclosure. The PBF AM system 400 includes a build powder reservoir 402 that includes fresh build powder of a first material 404a, e.g., a conventional high temperature capable alloy, and fresh build powder of a second material 404b, e.g., a hydrogen-compatible alloy, that are both available for use during a PBF AM build campaign to build the bimetallic hydrogen fuel nozzle 100 of this disclosure. The build powder beds 406a on the first material and 406b of the second material that are in active use during a PBF AM build campaign are positioned on a build plate 408 that is configured to operate in a build chamber 410 based on movement of a build piston 412. After an initial charge of build powder bed 406a, 406b from the build powder reservoir 402 is placed onto the build plate 408 in the build chamber 410, an energy source 414 with scanning system 415 scans an energy source 416 over a top layer 418 of the build powder beds 406a, 406b. As discussed above, the energy source 416 can be a laser (for a PBF-LB process) or an electron beam (for a PBF-EB process). The energy source 416 fuses, sinters, or consolidates selected portions of the top layer 418 as it scans across the top layer 418. As known in the art, the energy source scanning system 415 can be programmed to deliver a predetermined energy/power input with a predetermined scan pattern, scan rate, and energy source 416 power level to build a single layer of the bimetallic hydrogen fuel nozzle 100.

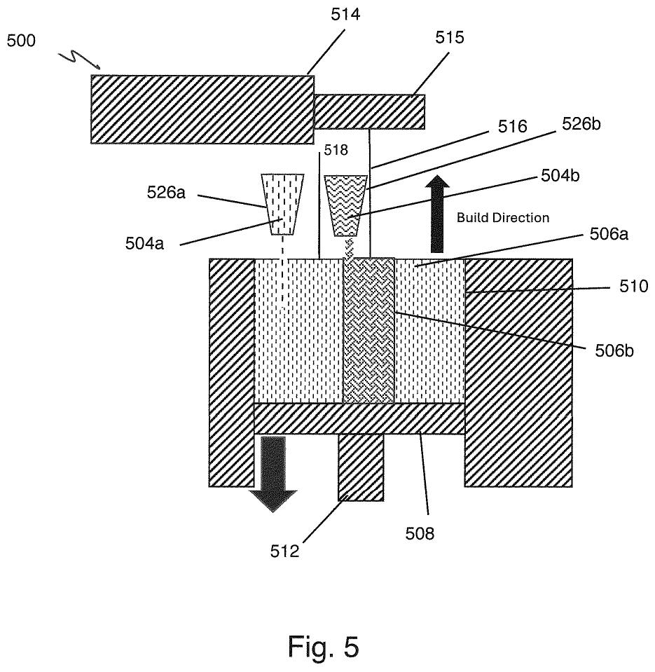

After the single layer of the bimetallic hydrogen fuel nozzle 100 is built, the build plate 408 is lowered, and a fresh powder distributor 426 is used to spread another layer of fresh powder feedstock 404a, 404b from build powder reservoir 402 on top of the build powder bed 406a, 406b. The fresh build powder distributor can be any device configured to distribute a layer of fresh build powder 404a, 404b on top of the build powder bed 406a, 406b such that the layer of fresh build powder 404a, 404b is level and smooth. Examples of suitable fresh build powder distributors include the recoater 426 of FIGS. 4 and the fresh build powder distributors 526a, 526b of FIG. 5. A person of ordinary skill will recognize that other devices suitable for distributing a layer of fresh build powder 404a, 404b on top of the build powder beds 406a, 406b are available.

In the example of FIG. 4, the build piston 412 lowers the build plate 408 in the build chamber 410 to create space to spread a layer of fresh build powder 404a, 404b on top of the build powder bed 406a, 406b. In the example depicted in FIG. 4, a build powder piston 422 in the build powder reservoir raises a build powder plate 424 to raise a quantity of fresh build powder 404a, 404b that a recoater 426 spreads on top of the build powder beds 406a, 406b. The recoater 426 typically travels across (traverses) the entire surface of the build chamber 110 to provide an even layer of fresh build powder 404a, 404b on top of the build powder bed 106. Following distribution of fresh build powder 104 on top of the build powder beds 406a, 406b, the energy source scanning system 415 scans the top layer of the build powder beds 406a, 406b to form the next layer of bimetallic hydrogen fuel nozzle 100. This process is repeated until the entire bimetallic hydrogen fuel nozzle 100 is built.

FIG. 5 shows another example of a PBF AM system 500 that can be used to implement PBF-L and PBF-EB AM techniques to build the bimetallic hydrogen fuel nozzle 100 of this disclosure. Fresh build powder distributors 526a (for fresh build powder of a first material 504a, e.g., a conventional high temperature capable alloy) and 526b (for fresh build powder of a second material 504b, e.g., a hydrogen-compatible alloy) so that both are available for use during a PBF AM build campaign to build the bimetallic hydrogen fuel nozzle 100 of this disclosure. After an initial charge of build powder bed 506a, 506b is placed onto the build plate 508 in the build chamber 510, an energy source 514 with scanning system 515 scans an energy source 516 over a top layer 518 of the build powder beds 506a, 506b. As discussed above, the energy source 516 can be a laser (for a PBF-LB process) or an electron beam (for a PBF-EB process). The energy source 516 fuses, sinters, or consolidates selected portions of the top layer 518 as it scans across the top layer 518. As known in the art, the energy source scanning system 515 can be programmed to deliver a predetermined energy/power input with a predetermined scan pattern, scan rate, and energy source 516 power level to build a single layer of the bimetallic hydrogen fuel nozzle 100.

After the single layer of the bimetallic hydrogen fuel nozzle 100 is built, the build plate 508 is lowered, and fresh powder distributors 526a, 526b is used to spread another layer of fresh powder feedstock 504a, 504b on top of the build powder beds 506a, 506b.

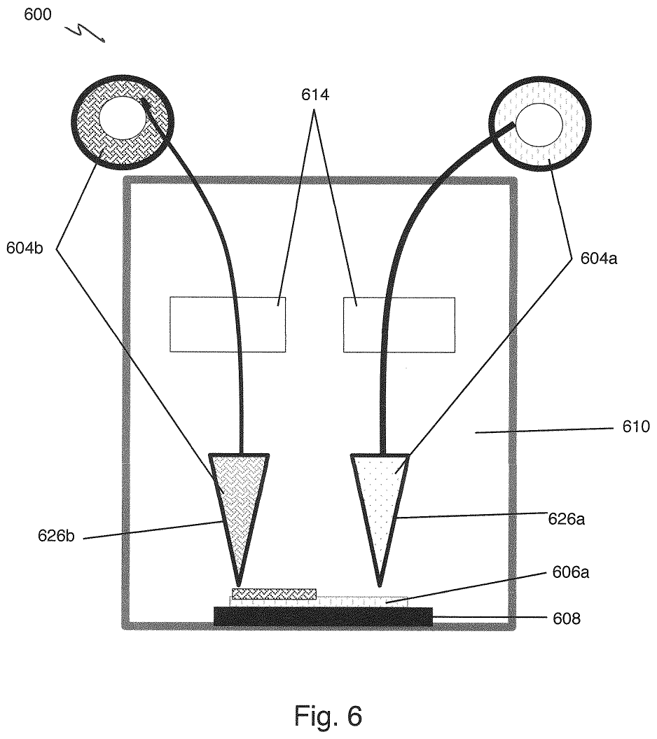

FIG. 6 shows an example of a DED-AW system 600 that can be used to implement DED-AW AM techniques to build the bimetallic hydrogen fuel nozzle 100 of this disclosure. Fresh build material of a first material 604a, e.g., a conventional high temperature capable alloy, and a second material 604b, e.g., a hydrogen-compatible alloy, is directed to build material nozzles 626a and 626b through energy sources 614 so that both the first material 604a and second material 604b are available for use during a DED-AW AM build campaign to build the bimetallic hydrogen fuel nozzle 100 of this disclosure. The build material nozzles 626a and 626b direct the first material 604a and second material 604b onto a printing bed 608 to build the bimetallic hydrogen fuel nozzle 100 of this disclosure.

In some examples, AM techniques can be combined to build the bimetallic hydrogen fuel nozzle 100 of this disclosure. For example, portions of the bimetallic hydrogen fuel nozzle 100 that are deemed to be in a “non-hydrogen-exposed zone” can be made with a conventional high temperature capable alloy using a first AM technique and portions of the bimetallic hydrogen fuel nozzle 100 that are deemed to be in a “hydrogen-exposed zone” can be made with a hydrogen-compatible alloy using a second AM technique. In some examples, the first AM technique can be PBF-LB or another AM technique and the second AM technique can be PBF-EB, DED-LP, DED-EBW, DED-AW, Cold Spray or another AM technique. Other combinations of first AM technique and second AM technique can be used as deemed appropriate for a particular application.

The disclosed bimetallic hydrogen fuel nozzles address many of the challenges associated with using hydrogen as a fuel for aircraft engines. These include use of AM techniques to reduce or eliminate the need for connected joints and the use of hydrogen-compatible alloys that are less susceptible to hydrogen embrittlement.

### Discussion of Possible Embodiments

The following are non-exclusive descriptions of possible embodiments of the present invention.

A hydrogen fuel nozzle for a gas turbine engine has a plurality of flow circuits, each of which is configured to flow one of a fuel or an oxidizer to a gas turbine engine combustor positioned downstream of the hydrogen fuel nozzle when the gas turbine engine is assembled. At least one of the plurality of flow circuits is a hydrogen flow circuit configured to flow hydrogen to the gas turbine engine combustor. The hydrogen fuel nozzle is formed using an additive manufacturing (AM) technique. A non-hydrogen-exposed zone of the hydrogen fuel nozzle is made with a first material which is a conventional high temperature capable alloy. A hydrogen-exposed zone of the hydrogen fuel nozzle is made with a second material, which is a hydrogen-compatible alloy.

The component protection casing of the preceding paragraph can optionally include, additionally and/or alternatively, any one or more of the following features, configurations and/or additional elements:

The AM technique is at least one of laser powder bed fusion, electron beam powder bed fusion, laser powder directed energy deposition, electron beam wire directed energy deposition, arc wire directed energy deposition, cold spray, binder jetting, and metal extrusion.

The AM technique is laser powder bed fusion.

The AM technique is arc wire directed energy deposition.

The AM technique is a combination of a first AM technique and a second AM technique.

The first AM technique is laser powder bed fusion and the second AM technique is one of electron beam powder bed fusion, laser powder directed energy deposition, electron beam wire directed energy deposition, arc wire directed energy deposition, cold spray, binder jetting, and metal extrusion.

The conventional high temperature capable alloy is one MAR-M200, Waspaloy, Rene 95, Inconel® 100 superalloy, GRCop-84, and GRCop-42.

The hydrogen-compatible alloy is one of Inconel® 600 nickel-chromium-iron superalloy, Inconel® 625 nickel-chromium superalloy, and NASA HR-1 iron-nickel superalloy. The hydrogen fuel nozzle has three flow circuits.

A primary flow circuit is configured to flow a liquid hydrocarbon fuel to the gas turbine engine combustor, a secondary flow circuit is configured to flow an oxidizer to the gas turbine engine combustor, and a tertiary flow circuit is configured to flow hydrogen to the gas turbine engine combustor.

A method of making a hydrogen fuel nozzle for a gas turbine engine includes forming a hydrogen fuel nozzle using an AM technique. A non-hydrogen-exposed zone of the hydrogen fuel nozzle is made with a first material which is a conventional high temperature capable alloy. A hydrogen-exposed zone of the hydrogen fuel nozzle is made with a second material, which is a hydrogen-compatible alloy. The hydrogen fuel nozzle has a plurality of flow circuits, each of which is configured to flow one of a fuel or an oxidizer to a gas turbine engine combustor positioned downstream of the hydrogen fuel nozzle when the gas turbine engine is assembled. At least one of the plurality of flow circuits is a hydrogen flow circuit configured to flow hydrogen to the gas turbine engine combustor. The hydrogen fuel nozzle is post-processed to remove support structures formed in the hydrogen fuel nozzle during the AM process. A surface finishing operation is performed on the hydrogen flow circuit to provide an inside diameter of the hydrogen flow circuit with a surface finish selected to limit hydrogen embrittlement.

The method of the preceding paragraph can optionally include, additionally and/or alternatively, any one or more of the following features, configurations and/or additional elements:

The AM technique is at least one of laser powder bed fusion, electron beam powder bed fusion, laser powder directed energy deposition, electron beam wire directed energy deposition, arc wire directed energy deposition, cold spray, binder jetting, and metal extrusion.

The AM technique is laser powder bed fusion.

The AM technique is arc wire directed energy deposition.

The AM technique is a combination of a first AM technique and a second AM technique.

The first AM technique is laser powder bed fusion and the second AM technique is one of electron beam powder bed fusion, laser powder directed energy deposition, electron beam wire directed energy deposition, arc wire directed energy deposition, cold spray, binder jetting, and metal extrusion.

The conventional high temperature capable alloy is one MAR-M200, Waspaloy, Rene 95, Inconel® 100 superalloy, GRCop-84, and GRCop-42.

The hydrogen-compatible alloy is one of Inconel® 600 nickel-chromium-iron superalloy, Inconel® 625 nickel-chromium superalloy, and NASA HR-1 iron-nickel superalloy. The hydrogen fuel nozzle is formed with three flow circuits.

A primary flow circuit is configured to flow a liquid hydrocarbon fuel to the gas turbine engine combustor, a secondary flow circuit is configured to flow an oxidizer to the gas turbine engine combustor, and a tertiary flow circuit is configured to flow hydrogen to the gas turbine engine combustor.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A hydrogen fuel nozzle for a gas turbine engine comprising:
a plurality of flow circuits, each of which is configured to flow one of a fuel or an oxidizer to a gas turbine engine combustor positioned downstream of the hydrogen fuel nozzle when the gas turbine engine is assembled, wherein at least one of the plurality of flow circuits is a hydrogen flow circuit configured to flow hydrogen to the gas turbine engine combustor;
wherein:
the hydrogen fuel nozzle is formed using an additive manufacturing (AM) technique;
a non-hydrogen-exposed zone of the hydrogen fuel nozzle is made with a first material, wherein the first material is a conventional high temperature capable alloy; and
a hydrogen-exposed zone of the hydrogen fuel nozzle is made with a second material, wherein the second material is a hydrogen-compatible alloy.

2. The hydrogen fuel nozzle of claim 1, wherein the AM technique is at least one of laser powder bed fusion, electron beam powder bed fusion, laser powder directed energy deposition, electron beam wire directed energy deposition, arc wire directed energy deposition, cold spray, binder jetting, and metal extrusion.

3. The hydrogen fuel nozzle of claim 2, wherein the AM technique is laser powder bed fusion.

4. The hydrogen fuel nozzle of claim 2, wherein the AM technique is arc wire directed energy deposition.

5. The hydrogen fuel nozzle of claim 2, wherein the AM technique is a combination of a first AM technique and a second AM technique.

6. The hydrogen fuel nozzle of claim 5, wherein the first AM technique is laser powder bed fusion and the second AM technique is one of electron beam powder bed fusion, laser powder directed energy deposition, electron beam wire directed energy deposition, arc wire directed energy deposition, cold spray, binder jetting, and metal extrusion.

7. The hydrogen fuel nozzle of claim 1, wherein the conventional high temperature capable alloy is one MAR-M200, Waspaloy, Rene 95, Inconel® 100 superalloy, GRCop-84, and GRCop-42.

8. The hydrogen fuel nozzle of claim 1, wherein the hydrogen-compatible alloy is one of Inconel® 600 nickel-chromium-iron superalloy, Inconel® 625 nickel-chromium superalloy, and NASA HR-1 iron-nickel superalloy.

9. The hydrogen fuel nozzle of claim 1 having three flow circuits.

10. The hydrogen fuel nozzle of claim 9, wherein a primary flow circuit is configured to flow a liquid hydrocarbon fuel to the gas turbine engine combustor, a secondary flow circuit is configured to flow an oxidizer to the gas turbine engine combustor, and a tertiary flow circuit is configured to flow hydrogen to the gas turbine engine combustor.

11. A method of making a hydrogen fuel nozzle for a gas turbine engine comprising:
integrally forming, using a continuous additive manufacturing (AM) technique, a hydrogen fuel nozzle from a first material and a second material, wherein the hydrogen fuel nozzle has a plurality of flow circuits, wherein each of the plurality of flow circuits is configured to flow one of a fuel or an oxidizer to a gas turbine engine combustor positioned downstream of the hydrogen fuel nozzle when the gas turbine engine is assembled, and wherein at least one of the plurality of flow circuits is a hydrogen flow circuit configured to flow hydrogen to the gas turbine engine combustor, wherein:
a non-hydrogen-exposed zone of the hydrogen fuel nozzle is made with the first material, wherein the first material is a conventional high temperature capable alloy; and
a hydrogen-exposed zone of the hydrogen fuel nozzle is made with the second material, wherein the second material is a hydrogen-compatible alloy;
post-processing the hydrogen fuel nozzle to remove support structures formed in the hydrogen fuel nozzle during the AM process; and
performing a surface finishing operation on the hydrogen flow circuit to provide an inside diameter of the hydrogen flow circuit with a surface finish selected to limit hydrogen embrittlement.

12. The method of claim 11, wherein the AM technique is at least one of laser powder bed fusion, electron beam powder bed fusion, laser powder directed energy deposition, electron beam wire directed energy deposition, arc wire directed energy deposition, cold spray, binder jetting, and metal extrusion.

13. The method of claim 12, wherein the AM technique is laser powder bed fusion.

14. The method of claim 12, wherein the AM technique is arc wire directed energy deposition.

15. The method of claim 12, wherein the AM technique is a combination of a first AM technique and a second AM technique.

16. The method of claim 15, wherein the first AM technique is laser powder bed fusion and the second AM technique is one of electron beam powder bed fusion, laser powder directed energy deposition, electron beam wire directed energy deposition, arc wire directed energy deposition, cold spray, binder jetting, and metal extrusion.

17. The method of claim 11, wherein the conventional high temperature capable alloy is one MAR-M200, Waspaloy, Rene 95, Inconel® 100 superalloy, GRCop-84, and GRCop-42.

18. The method of claim 11, wherein the hydrogen-compatible alloy is one of Inconel® 600 nickel-chromium-iron superalloy, Inconel® 625 nickel-chromium superalloy, and NASA HR-1 iron-nickel superalloy.

19. The method of claim 11, wherein the hydrogen fuel nozzle is formed with three flow circuits.

20. The method of claim 19, wherein a primary flow circuit is configured to flow a liquid hydrocarbon fuel to the gas turbine engine combustor, a secondary flow circuit is configured to flow an oxidizer to the gas turbine engine combustor, and a tertiary flow circuit is configured to flow hydrogen to the gas turbine engine combustor.
